(19) United States
(12) Patent Application Publication
(10) Pub. No.: US 2021/0150791 A1
(43) Pub. Date: May 20, 2021

(54) APPARATUS AND METHOD FOR AUTHORING MOTION OF AN AVATAR

(71) Applicant: Artificial Intelligence Research Institute, Seongnam-si (KR)

(72) Inventor: Dae Seoung KIM, Seoul (KR)

(73) Assignee: Artificial Intelligence Research Institute, Seongnam-si (KR)

(21) Appl. No.: 16/703,769

(22) Filed: Dec. 4, 2019

(30) Foreign Application Priority Data
Nov. 18, 2019 (KR) 10-2019-0147623

(51) Int. Cl. G06T 13/40; G06T 17/00; G06T 19/20; G06T 7/246

(52) U.S. Cl. CPC G06T 13/40; G06T 17/005; G06T 2200/08; G06T 7/248; G06T 19/20

(57) ABSTRACT

Provided is an apparatus for authoring a motion of an avatar, the apparatus capable of editing a motion of an avatar by defining a body of the avatar using a hierarchical tree structure, selecting a motion clip corresponding to a level of a body part corresponding to a node selected using the tree structure, and assigning the selected motion clip and a sub-motion clip as motion clips of the body part of the selected node and a sub-body part.

### CROSS-REFERENCE TO RELATED APPLICATION(S)

This application claims priority from Korean Patent Application No. 10-2019-0147623, filed on Nov. 18, 2019, in the Korean Intellectual Property Office, the disclosure of which is incorporated herein by reference in its entirety.

### BACKGROUND

### 1. Field

The following description relates to an apparatus and method for authoring a motion of an avatar, and more particularly, to an apparatus and method for defining a body of an avatar using a hierarchical tree structure and editing a motion of a body part corresponding to an upper node of the tree structure by assigning a motion clip to a body part corresponding to a lower node of the tree structure.

### 2. Description of Related Art

Images of simple figures called avatars are being used in various fields. In particular, avatars are used as characters in games, characters in virtual spaces, part of content delivered in communication tools such as chats or email, and so on.

A character generating device and method are disclosed in Japanese Laid-Open Patent Publication No. 2006-119788. The character generating device generates a character by combining contours and elements of the character using connection points and a reference point.

Japanese Laid-Open Patent Publication No. 2006-119788 is disadvantageous in that it is inconvenient to set the reference point and the connection points to combine the elements and does not disclose a configuration for expressing motions of a character.

Recently, motions of avatars have been represented using three-dimensional (3D) graphic technology but devices are required to be capable of performing professional graphic work to edit such motions, and a great deal of work is required to create various motions.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The following description relates to providing a hierarchical avatar motion authoring apparatus capable of editing a motion of an entire body by combining motion clips of individual parts of the body.

In addition, the following description relates to providing an avatar motion authoring apparatus capable of representing various motions with a small number of motion clips.

In one general aspect, an avatar motion authoring apparatus includes a motion clip selector, a motion clip database, and a motion editor.

The motion clip selector may visually present body parts to a user according to a tree structure and select a motion clip corresponding to a level of a body part corresponding to a tree node selected by the user.

The motion clip database may store a motion clip for each body part of an avatar in association with a body tree structure.

The motion editor may edit a motion of the avatar by extracting the selected motion clip and sub-motion clips thereof from the motion clip database and assigning the motion clip and the sub-motion clips as motion clips of the body part of the selected tree node and inferior-body parts thereof.

In another general aspect, the avatar motion authoring apparatus may further include a tree creator configured to create a body of the avatar by defining the body of the avatar using a tree structure.

In another general aspect, the avatar motion authoring apparatus may further include a motion reproducer configured to reproduce and display a created motion of the avatar.

In one general aspect, the motion reproducer may reproduce and display a motion of a body part of a node selected in the tree structure and motions of inferior-body parts thereof.

In another general aspect, the avatar motion authoring apparatus may further include a motion modifier configured to change the motion of the body part of the node selected in the tree structure to another selected motion clip with respect to the created motion of the avatar.

In another general aspect, the avatar motion authoring apparatus may further include an attribute adder configured to the created motion of the avatar by adding an attribute to the motion of the body part of the node selected in the body tree structure.

In one general aspect, the attribute added to the motion may include at least one of an angle or speed of the motion.

In one embodiment of the present disclosure, a method of authoring a motion of an avatar performed by an avatar motion authoring apparatus includes visually presenting a tree structure and body parts of the avatar according to the tree structure to the user, selecting a tree node of a body part to be edited according to a user input, selecting a motion clip corresponding to a level of the body part of the tree node selected according to the user input, and editing a motion of the avatar by extracting the selected motion clip from a motion clip database and assigning the extracted motion clip as a motion clip of the body part of the selected tree node. In this case, the selecting of the tree node, the selecting of the motion clip, and the editing of the motion of the avatar are repeatedly performed until the motion of the avatar is completed.

In another embodiment of the present disclosure, the method may further include storing a completed motion clip of the avatar in association with a body tree structure.

In another embodiment of the present disclosure, the method may further include storing the motion clip of the body part of the edited tree node or motion clips of the body part and inferior-body parts thereof in association with a body tree structure.

In another embodiment of the present disclosure, the method may further include creating a body of the avatar by defining the body of the avatar using the tree structure.

In another embodiment of the present disclosure, the method may further include reproducing and displaying the created motion.

In another embodiment of the present disclosure, the method may further include reproducing and displaying a motion of a body part of a node selected in the tree structure and a motion of an inferior-body part.

In another embodiment of the present disclosure, the method may further include changing a motion of a body part of a node selected in the tree structure to another selected motion clip with respect to a created motion of the avatar.

In another embodiment of the present disclosure, the method may further include changing a created motion of the avatar by adding an attribute to a motion of a body part of a node selected in the tree structure.

Other features and aspects will be apparent from the following detailed description, the drawings, and the claims.

### BRIEF DESCRIPTION OF THE DRAWINGS

FIG. 1 is a diagram illustrating an example of hierarchically defining a body of an avatar using a tree structure;

FIG. 2 is a block diagram illustrating an example of a configuration of an avatar motion authoring apparatus;

FIG. 3 is a block diagram illustrating an example of a configuration of an avatar motion authoring apparatus according to various aspects;

FIG. 4 is a flowchart of an avatar motion authoring method according to an embodiment of the present disclosure;

FIG. 5 is a flowchart of an avatar motion authoring method which includes defining a tree structure and storing a motion clip according to another embodiment of the present disclosure; and

FIG. 6 is a flowchart of an avatar motion authoring method which includes reproducing a created motion and modifying a motion clip according to another embodiment of the present disclosure.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The foregoing and further aspects will be implemented through embodiments described with reference to the accompanying drawings below. It should be understood that components of embodiments can be implemented in various combinations in the embodiments unless mentioned otherwise and as long as there is no contradiction between components. Each block of block diagrams may represent a physical component in some cases but may be a logical representation of part of functions of a physical component or a function performed by a plurality of physical components. In some cases, an entity of a block or part thereof may be a set of program instructions. All or some of such blocks may be implemented by hardware, software or a combination thereof.

An avatar motion authoring apparatus 10 according to the present disclosure may be embodied as a computing apparatus which includes a microprocessor, a memory, a display, and the like. The microprocessor executes a program stored in the memory to author a motion of an avatar according to a user input. A user may select a body part to be edited through a user interface provided by the avatar motion authoring apparatus 10 and select and assign a desired motion clip to the body part.

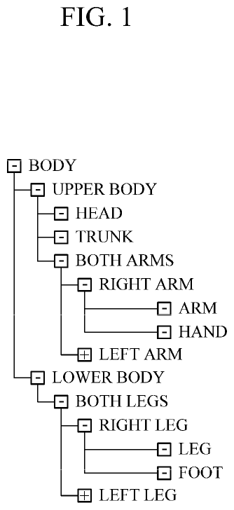

FIG. 1 is a diagram illustrating an example of hierarchically defining a body of an avatar using a tree structure. According to the present disclosure, a body of an avatar is represented by hierarchically defining it using a tree structure as illustrated in FIG. 1. According to the example of FIG. 1, the body of the avatar is set as a root node, and a body node includes child nodes, i.e., an upper-body node and a lower-body node, as lower nodes. The upper-body node has the body node as a parent node, i.e., an upper node, and has a head node, a trunk node, and a both-arms node as child nodes. In the above example, the head node and the trunk node are leaf nodes each having the upper-body node as a parent node and having no child nodes. The both-arms node includes a right-arm node and a left-arm node as child nodes each having an arm node and a hand node as child nodes. The lower-body node includes a both-legs node as a child node, the both-legs node has a right-leg node and a left-leg node as child nodes, and the right-left node and the left-leg node each have a leg node and a foot node as child nodes. In the case of a motion of an avatar according to the present disclosure, when a motion clip is assigned to a body part corresponding to a leaf node in the tree structure, motions of upper nodes of the left node are authored. For example, a motion of the left-arm node is configured by assigning motion clips to the arm node and the hand node thereof. Such a body tree structure may be stored in the form of meta information in a file storing motions of the avatar but is not limited thereto and may be separately stored in the form of a meta file. A format of the meta information or the meta file is not limited and may be defined using a markup language such as Extensible Markup Language (XML).

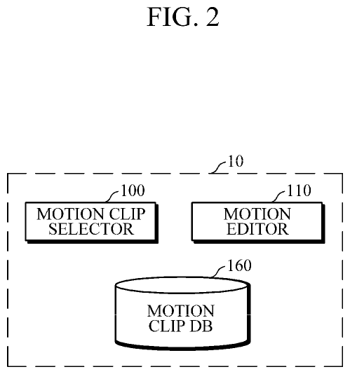

FIG. 2 is a block diagram illustrating an example of a configuration of an avatar motion authoring apparatus. An avatar motion authoring apparatus 10 according to an aspect of the present disclosure includes a motion clip selector 100, a motion clip database (DB) 160, and a motion editor 110.

The motion clip selector 100 and the motion editor 110 may be configured as a set of program instructions executed by a microprocessor of the avatar motion authoring apparatus 10 which is a computing apparatus.

A motion clip is an animation object which is a representation of a motion of a corresponding body part and may be either a short image file storing the motion of the body part or a file storing meta information indicating an object representing the body part and a motion of the object according to an aspect of the present disclosure. However, the motion clip is not limited thereto and a form of data visually representing the motion of the body part is not limited.

The motion clip selector 100 visually presents body parts to a user according to a tree structure. That is, when a tree node selected by the user in a body tree structure displayed on a user interface is a leaf node, the motion clip selector 100 displays a body part corresponding to the tree node on a screen, and when the tree node is not a leaf node, the motion clip selector 100 displays the body part corresponding to the tree node and body parts corresponding to sub-nodes of the tree node on the screen. In addition, the motion clip selector 100 provides a user interface for selecting a motion clip corresponding to a level of the body part of the tree node selected by the user and receives a selected motion clip from the user via the user interface.

The motion clip DB 160 stores a motion clip for each body part of an avatar in association with the body tree structure. The motion clip DB 160 stores not only motion clips of body parts corresponding to leaf nodes of the body tree structure of the avatar but also motion clips of upper nodes that are results obtained by combining or synthesizing the motion clips of the leaf nodes and stores meta information indicating a node to which each of the motion clips is assigned.

The motion editor 110 edits a motion of the avatar by extracting a motion clip selected via the motion clip selector 100 and sub-motion clips of the motion clip from the motion clip DB 160 and assigning the motion clip and the sub-motion clips to a body part of a selected tree node and inferior-body parts. However, when the selected tree node is a leaf node of the body tree structure of the avatar, only the selected motion clip is extracted from the motion clip DB 160 and assigned as a motion clip of the body part of the selected tree node.

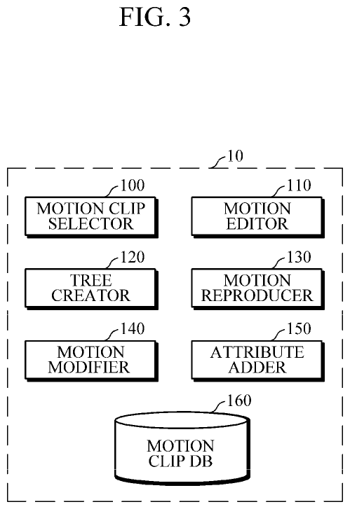

FIG. 3 is a block diagram illustrating an example of a configuration of an avatar motion authoring apparatus according to various aspects. An avatar motion authoring apparatus 10 includes a motion clip selector 100, a motion clip DB 160, and a motion editor 110. In another aspect, the avatar motion authoring apparatus 10 may further include at least one of a tree creator 120, a motion reproducer 130, a motion modifier 140, or an attribute adder 150.

The tree creator 120, the motion reproducer 130, the motion modifier 140, and the attribute adder 150 may be configured as a set of program instructions executed by a microprocessor of the avatar motion authoring apparatus 10 which is a computing apparatus.

The tree creator 120 may create a body of an avatar by defining it using a tree structure. A user may define a body tree structure of the avatar according to a desired degree of motion of the avatar. For example, when a large amount of motion of a lower body of the avatar is not required, the lower body may be defined as one leaf node instead of subdividing the lower body in the tree structure. When the avatar is different from a shape of a human being, the body of the avatar may be defined according to the shape of the human being. Accordingly, the user may variously define the tree structure through the tree creator 120 according to a desired motion level of the avatar.

The motion reproducer 130 may reproduce and display a created motion of the avatar. The motion reproducer 130 may reproduce the created motion of the avatar to check whether a desired motion is completed and reproduce and check not only all motions but also motions of each body part and inferior-body parts when the motion of each body part is edited. That is, the motion reproducer 130 may reproduce and display a motion of a body part of a node selected in the tree structure and motions of inferior-body parts.

The motion modifier 140 may change a motion of a body part of a node selected in the tree structure to another selected motion clip with respect to the created motion of the avatar. When the created motion of the avatar is necessary to be modified or when an already stored motion of the avatar corresponding to a specific body part is to be extracted from a database and modified to be used, the motion modifier 140 may change a motion clip already assigned to the body part to another motion clip. For example, when only a hand motion is to be changed among all created motions of the avatar, the hand motion may be changed by selecting a tree node corresponding to a hand in the tree structure and selecting a new motion clip via a user interface for selecting a motion clip for a corresponding body part. Similarly, when there is an already created stored motion clip for a specific body part and only some motions are to be used by changing the motions using the motion clip, the motion clip may be extracted, a tree node to be changed may be selected in the tree structure, and another motion clip for a corresponding body part may be selected.

The attribute adder 150 may change the created motion by adding an attribute to a motion of a body part of a node selected in the tree structure. According to an aspect of the present disclosure, the attribute added to the motion may include at least one of an angle or speed of the motion. That is, when the speed or degree of an already created motion of a body part is to be represented to be increased, the motion may be changed by adding an attribute to a motion clip corresponding thereto.

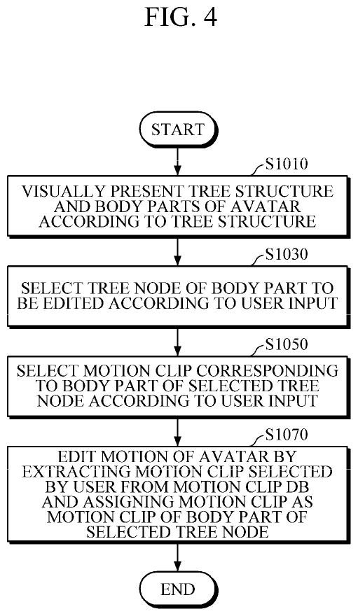

FIG. 4 is a flowchart of an avatar motion authoring method according to an embodiment of the present disclosure. In the present disclosure, a body of an avatar body is identified as a hierarchical structure and defined using a tree structure. Thus, the avatar motion authoring apparatus 10 of the present disclosure presents a tree structure corresponding to the body of the avatar to a user so that the user may use the tree structure to edit a motion. In addition, when the user selects a specific node in the tree structure, the avatar motion authoring apparatus 10 visually displays a body part corresponding to the tree node so that the body part, the motion of which is to be edited, may be recognized visually and immediately. That is, according to an embodiment of the present disclosure, an avatar motion authoring method performed by the avatar motion authoring apparatus 10 includes visually presenting a tree structure and body parts of an avatar according to the tree structure to a user (S1010) and selecting a tree node of a body part to be edited according to a user input (S1030). In this case, the body part corresponding to the selected tree node may be displayed as a node to be edited on a screen.

The avatar motion authoring apparatus 10 provides the user with motion clips of selected body parts in the form of a list or thumbnail so that the user may select a specific motion. In one embodiment of the present disclosure, the avatar motion authoring method performed by the avatar motion authoring apparatus 10 includes selecting a motion clip corresponding to a level of the body part of the selected tree node according to a user input (S1050). In this case, the list or thumbnail of the provided motion clips is displayed by extracting motion clips previously stored in the motion clip DB 160. The motion clip may be a motion clip of a body part including a lower node or having no lower node. The motion clips are stored in association with a body tree structure of the avatar, that is, are stored to include meta information regarding the tree structure.

The avatar motion authoring method performed by the avatar motion authoring apparatus 10 includes editing a motion of the avatar by extracting a motion clip selected by the user via a user interface from the motion clip DB 160 and assigning the extracted motion clip as a motion clip of the body part of the selected tree node (S1070). In this case, when the selected tree node is a leaf node of the body tree structure of the avatar, only the selected motion clip is selected from the motion clip DB 160 and assigned as a motion clip of the body part of the selected tree node, and when the selected tree node is not a leaf node, the selected motion clip is assigned as motion clips for the body part of the tree node selected according to the body tree structure and inferior-body parts.

The user repeatedly performs the selecting of the tree node, the selecting of the motion clip, and the editing of the motion of the avatar via the user interface until the motion of the avatar is completed.

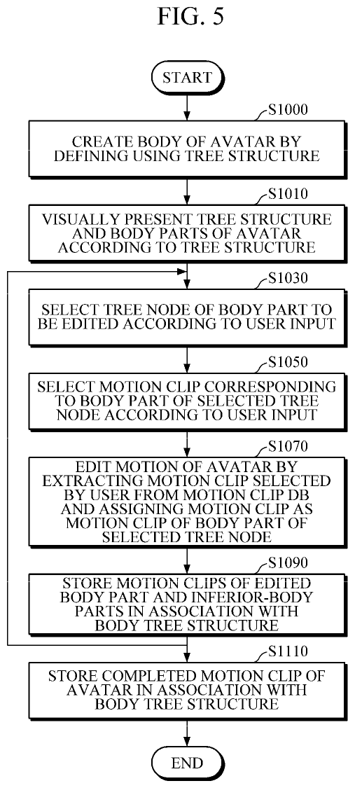

FIG. 5 is a flowchart of an avatar motion authoring method which includes defining a tree structure and storing a motion clip according to another embodiment of the present disclosure.

According to another embodiment of the present disclosure, the avatar motion authoring method performed by the avatar motion authoring apparatus 10 may further include storing a completed avatar motion clip in association with a body tree structure (S1110). The motion clip DB 160 may store not only motion clips of body parts corresponding to leaf nodes of the body tree structure of the avatar but also motion clips of upper nodes that are results of combining or synthesizing the motion clips of the leaf nodes and may store meta information regarding nodes of the body tree structure to which the motion clips are assigned.

The avatar motion authoring method performed by the avatar motion authoring apparatus 10 may further include storing either a motion clip of a tree node edited during editing of a motion or motion clips of the edited body part and inferior-body parts in association with the body tree structure (S1090), in addition to the storing of the completed avatar motion clip. When another motion of the avatar is authored, the stored motion clips may be extracted at a level of a corresponding body part from the motion clip DB 160 and displayed on an interface for selection of a motion clip. That is, the stored motion clips may be used again by extracting them from the motion clip DB 160 when the user edits another motion.

According to another embodiment of the present disclosure, the avatar motion authoring method performed by the avatar motion authoring apparatus 10 may further include creating a body of the avatar by defining it using a tree structure (S1000). The avatar motion authoring apparatus 10 may create a body of the avatar by defining the body using a tree structure. A user may define a body tree structure of the body of the avatar according to a desired degree of motion of the avatar. For example, when a large amount of motion of a lower body of the avatar is not required, the lower body may be defined as one leaf node instead of subdividing the lower body in the tree structure. When the avatar is different from a shape of a human being, the body of the avatar may be defined according to the shape of the human being. Accordingly, the user may variously define a tree structure via the user interface according to a desired motion level of the avatar.

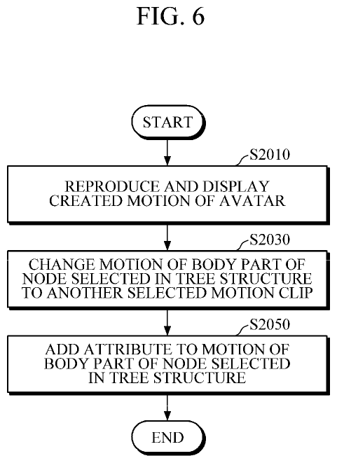

FIG. 6 is a flowchart of an avatar motion authoring method which includes reproducing a created motion and modifying a motion clip according to another embodiment of the present disclosure. The example of FIG. 6 illustrates a process after authoring of a motion of an avatar is completed, and a process of authoring the motion of the avatar is omitted here.

According to another embodiment of the present disclosure, the avatar motion authoring method performed by the avatar motion authoring apparatus 10 may further include reproducing and displaying a created motion of the avatar (S2010). The reproducing and displaying of the motion of the avatar may include reproducing and displaying a motion of a body part of a node selected from a tree structure and motions of inferior-body parts thereof.

The avatar motion authoring apparatus 10 may reproduce and display a created motion of the avatar. A user may reproduce the created motion of the avatar to check whether a desired motion is completed and reproduce and check not only all motions but also motions of each body part and inferior-body parts thereof when each body part is edited. That is, the avatar motion authoring apparatus 10 may reproduce and display motions of a body part of a node selected in the tree structure and inferior-body parts thereof.

According to another embodiment of the present disclosure, the avatar motion authoring method performed by the avatar motion authoring apparatus 10 may further include changing a motion of a body part of a node selected in the tree structure to another selected motion clip with respect to the created motion of the avatar (S2030). That is, the avatar motion authoring apparatus 10 may change the motion of the body part of the node selected in the tree structure to another selected motion clip with respect to the created motion of the avatar. That is, the motion clip of the selected node may be overwritten with another motion clip, i.e., may be modified, in a state in which a motion of an upper node of the selected node is edited. Thus, when modification of the created motion of the avatar is necessary or when an already stored avatar motion of a specific body part is to be extracted from a database, modified and used, the avatar motion authoring apparatus 10 may change a motion clip already assigned to the body part to another motion clip. For example, when only a hand motion is to be changed among all created motions of the avatar motion, the hand motion may be changed by selecting a tree node corresponding to a hand in the tree structure and selecting a new motion clip via a user interface for selecting a motion clip for a corresponding body part. Similarly, when there is an already created stored motion clip for a specific body part and only some motions are to be used by changing them using the motion clip, the motion clip may be extracted, a tree node to be changed may be selected in the tree structure, and another motion clip for a corresponding body part may be selected, modified, and used.

According to another embodiment of the present disclosure, the avatar motion authoring method performed by the avatar motion authoring apparatus 10 may further include changing the created motion of the avatar by adding an attribute to a motion of a body part of a node selected in the tree structure (S2050).

The avatar motion authoring apparatus 10 may change the created motion by adding an attribute to a motion of a body part of a node selected in the tree structure. According to an embodiment the present disclosure, the attribute added to the motion may include at least one of an angle or speed of the motion. That is, when the speed or degree of an already created motion of a body part is to be represented as being increased, the motion may be changed by adding an attribute to a motion clip corresponding thereto.

According to the present disclosure, an entire motion of an avatar may be easily edited by defining a body of the avatar using a hierarchical tree structure and editing a motion of an upper-body part by combining motion clips of individual body parts.

In addition, according to the present disclosure, a motion of an avatar capable of expressing various motions may be authored with a small number of motion clips.

While the present disclosure has been described above with respect to embodiments in conjunction with the accompanying drawings, the present disclosure is not limited thereto and should be interpreted to cover various modifications that will be apparent to those of ordinary skill in the art. The claims are intended to cover such modifications.

What is claimed is:

1. An apparatus for authoring a motion of an avatar, comprising:
a motion clip selector configured to visually present body parts to a user according to a tree structure and select a motion clip corresponding to a level of a body part corresponding to a tree node selected by the user;
a motion clip database storing motion clips corresponding to body parts of the avatar in association with the tree structure; and
a motion editor configured to edit a motion of the avatar by extracting the selected motion clip and sub-motion clips thereof from the motion clip database and assigning the motion clip and the sub-motion clips as motion clips of the body part of the selected tree node and inferior-body parts thereof.

2. The apparatus of claim 1, further comprising a tree creator configured to create a body of the avatar by defining the body of the avatar using the tree structure.

3. The apparatus of claim 1, further comprising a motion reproducer configured to reproduce and display a created motion of the avatar.

4. The apparatus of claim 3, wherein the motion reproducer reproduces and displays a motion of a body part of a node selected in the tree structure and motions of the inferior-body parts thereof.

5. The apparatus of claim 1, further comprising a motion modifier configured to change a motion of a body part of a node selected in the tree structure to another selected motion clip with respect to a created motion of the avatar.

6. The apparatus of claim 1, further comprising an attribute adder configured to add an attribute to a motion of a body part of a node selected in the tree structure so as to change a created motion of the avatar.

7. The apparatus of claim 6, wherein the attribute added to the motion comprises at least one of an angle or a speed of the motion.

8. A method of authoring a motion of an avatar by an avatar motion authoring apparatus, the method comprising:
visually presenting a tree structure and body parts of the avatar according to the tree structure to the user;
selecting a tree node of a body part to be edited according to a user input;
selecting a motion clip corresponding to a level of the body part of the tree node selected according to the user input; and
editing a motion of the avatar by extracting the selected motion clip from a motion clip database and assigning the extracted motion clip as a motion clip of the body part of the selected tree node,
wherein the selecting of the tree node, the selecting of the motion clip, and the editing of the motion of the avatar are repeatedly performed until the motion of the avatar are completed.

9. The method of claim 8, further comprising storing a completed motion clip of the avatar in association with a body tree structure.

10. The method of claim 8, further comprising storing the motion clip of the body part of the edited tree node or motion clips of the body part and inferior-body parts thereof in association with a body tree structure.

11. The method of claim 8, further comprising creating a body of the avatar by defining the body of the avatar using the tree structure.

12. The method of claim 8, further comprising reproducing and displaying a created motion of the avatar.

13. The method of claim 12, wherein the reproducing and displaying of the motion of the avatar comprises reproducing and displaying a motion of a body part of a node selected in the tree structure and motions of inferior-body parts of the body part.

14. The method of claim 8, further comprising changing a motion of a body part of a node selected in the tree structure to another selected motion clip with respect to a created motion of the avatar.

15. The method of claim 8, further comprising changing a created motion of the avatar by adding an attribute to a motion of a body part of a node selected in the tree structure.
